(19) United States
(12) Patent Application Publication
(10) Pub. No.: US 2003/0180105 A1
(43) Pub. Date: Sep. 25, 2003

(54) Tool-holding seat having bit-retention holes inclined relative to a bottom face of the tool-holding seat

(76) Inventor: Chieh-Jen Hsiao, Taichung City (TW)

Correspondence Address: NIXON & VANDERHYE, P.C., 1100 North Glebe Road, 8th Floor, Arlington, VA, 22201-4714, US

(21) Appl. No.: 10/101,234

(22) Filed: Mar. 21, 2002

(51) Int. Cl. B26D 1/00; B23B 49/00

(52) U.S. Cl. 407/120; 407/99

(57) ABSTRACT

A tool-holding seat includes a seat body having a flat bottom face and a flat top face opposite to the flat bottom face. The seat body is formed with a plurality of parallel spaced apart bit-retention holes which extend inwardly from the flat top face. Each of the bit-retention holes is capable of retaining a workpiece-driving bit therein, and defines an axial line along the length thereof. The axial line of each of the bit-retention holes is inclined relative to the flat bottom face at an acute angle. A magnetic piece is embedded in the seat body adjacent to the flat bottom face.

### BACKGROUND OF THE INVENTION

1. Field of the Invention

This invention relates to a tool-holding seat, more particularly to a tool-holding seat having bit-retention holes that are inclined relative to a bottom face of the tool-holding seat so as to facilitate insertion of and access to workpiece-driving bits in the bit-retention holes.

2. Description of the Related Art

Referring to FIG. 1, a conventional tool-holding seat 200 is shown to include an elongated seat body 5 defining a plurality of parallel spaced apart bit-retention holes 501 which extend inwardly from a flat top face thereof and which are capable of retaining workpiece-driving bits 7 therein, respectively. A magnet piece 6 is fixed to a flat bottom face of the seat body 5 so as to permit magnetic attachment of the tool-holding seat 200 on a flat surface of a working site.

It is inconvenient to insert and access the workpiece-driving bits in the bit-retention holes 501, since each bit-retention hole 501 defines an axial line perpendicular to the flat bottom face of the seat body 5.

### SUMMARY OF THE INVENTION

The main object of this invention is to provide a tool-holding seat having bit-retention holes that are inclined relative to a flat bottom face of the tool-holding seat so as to facilitate insertion of and access to workpiece-driving bits in the bit-retention holes.

Accordingly, a tool-holding seat of the present invention includes a seat body and a magnetic piece. The seat body has a flat bottom face and a flat top face opposite to the flat bottom face. The seat body is further formed with a plurality of parallel spaced apart bit-retention holes which extend inwardly from the flat top face. Each of the bit-retention holes is adapted to retain a workpiece-driving bit therein, and defines an axial line along the length thereof. The axial line of each of the bit-retention holes is inclined relative to the flat bottom face at an acute angle so as to facilitate insertion of and access to the workpiece-driving bits in the bit-retention holes. The magnetic piece is embedded in the seat body adjacent to the flat bottom face.

### BRIEF DESCRIPTION OF THE DRAWINGS

These and other features and advantages of this invention will become apparent in the following detailed description of the preferred embodiments of this invention, with reference to the accompanying drawings, in which:

FIG. 1 is a perspective view of a conventional tool-holding seat shown together with a plurality of workpiece-driving bits;

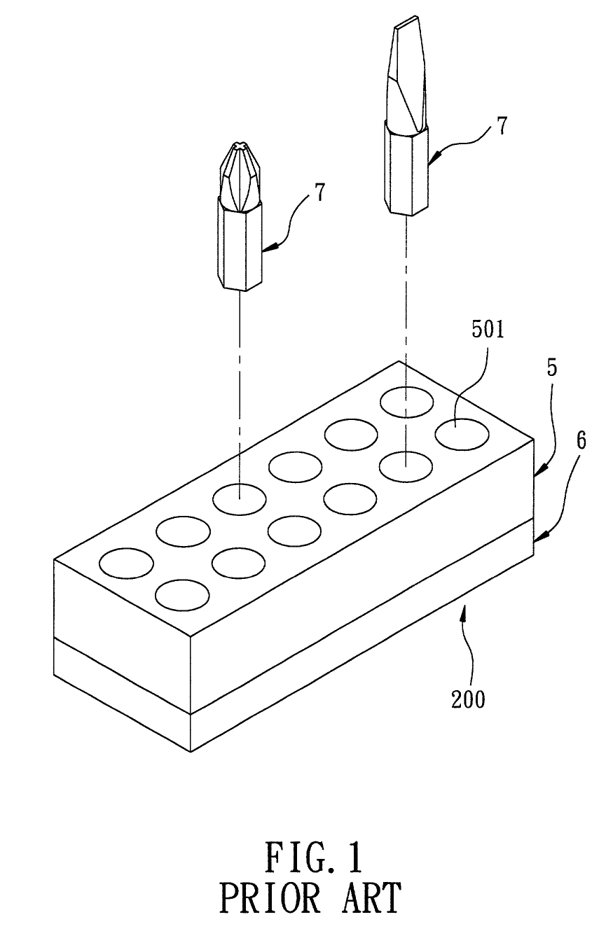

FIG. 2 is a perspective view of a first preferred embodiment of a tool-holding seat according to the present invention;

FIG. 3 is a sectional view of the first preferred embodiment, illustrating a state of use;

FIG. 4 is a sectional view of the first preferred embodiment, illustrating another state of use;

FIG. 5 is a sectional view of a second preferred embodiment of the present invention; and

FIG. 6 is a sectional view of a third preferred embodiment of the present invention.

### DETAILED DESCRIPTION OF THE PREFERRED EMBODIMENTS

Before the present invention is described in greater detail with reference to the following preferred embodiments, it should be noted that same reference numerals have been used to denote similar elements throughout the specification.

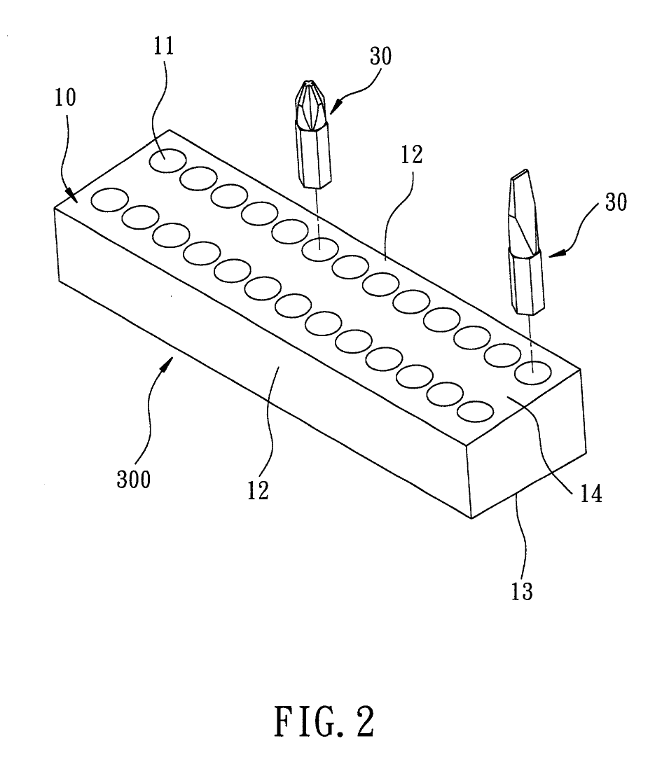

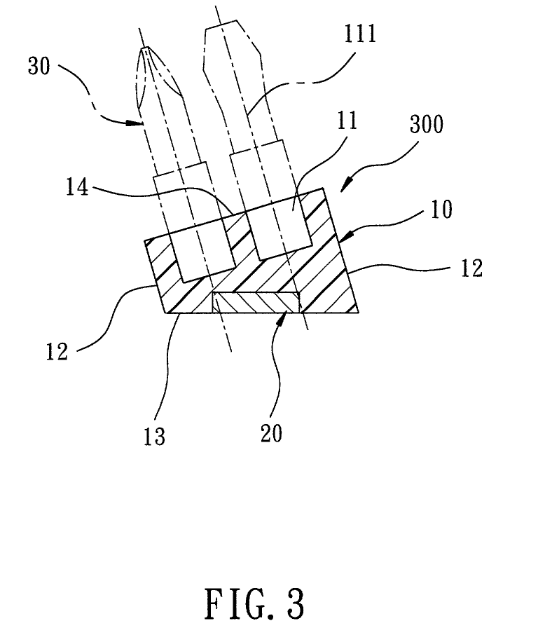

Referring to FIGS. 2 to 4, the preferred embodiment of a tool-holding seat 300 according to the present invention is shown to include a seat body 10 and a magnetic piece 20.

As illustrated, the seat body 10 has a flat bottom face 13 and a flat top face 14 opposite to the flat bottom face 13, and is formed with a plurality of parallel spaced apart bit-retention holes 11 which extend inwardly from the flat top face 14. Each of the bit-retention holes 11 is adapted to retain a workpiece-driving bit 30 therein, and defines an axial line 111 along the length thereof. The axial line 111 of each of the bit-retention holes 11 is inclined relative to the flat bottom face 13 at an acute angle so as to facilitate insertion of and access to the workpiece-driving bits 30 in the bit-retention holes

The magnetic piece 20 is embedded in the seat body 10, and is adjacent to and is flush with the flat bottom face 13.

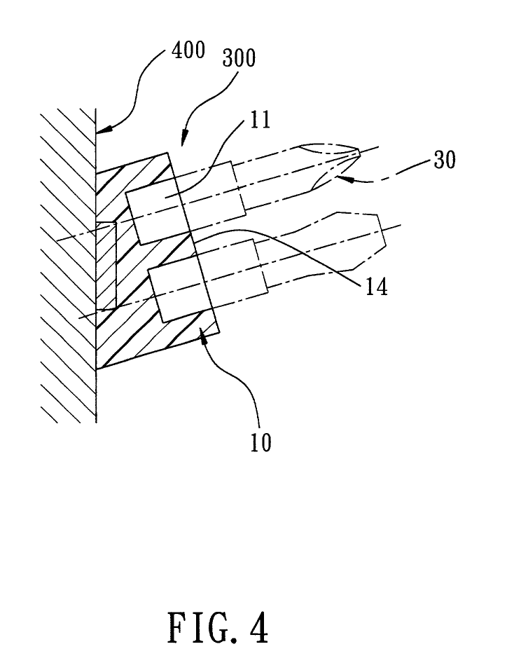

In this embodiment, the seat body 10 has two opposite inclined side faces 12 which extend from the flat bottom face 13 to the flat top face 14 in a direction parallel to the axial line 111. The flat top face 14 is inclined relative to the flat bottom face 13, and is perpendicular to the axial line of each of the bit-retention holes 11. FIG. 4 illustrates how the preferred embodiment can be mounted on a wall 400, such as a vehicle body, by magnetic attraction so as to facilitate working on the vehicle. Under this condition, the workpiece-driving bits 30 will not fall out from the bit-retention holes 11 by virtue of inclination of the flat top face 14 relative to the flat bottom face 13.

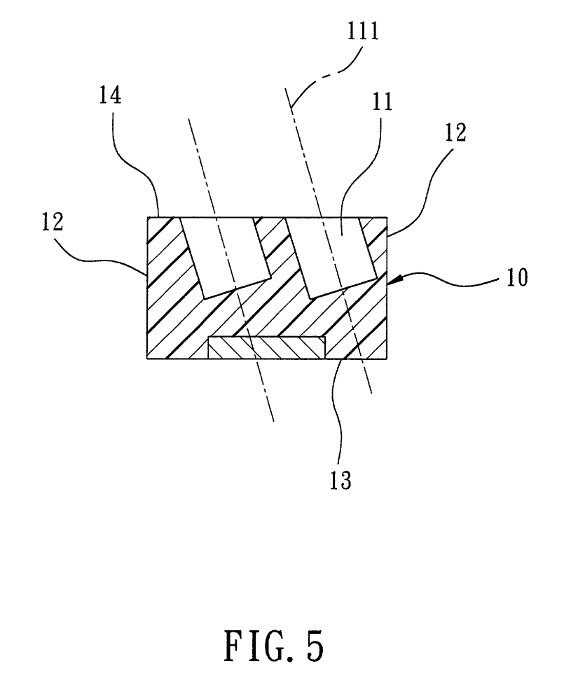

Referring to FIG. 5, a second preferred embodiment of the present invention is shown to have a structure similar to that of the first preferred embodiment. The main difference resides in that the seat body 10 has two opposite side faces 12 which extend from the flat bottom face 13 to the flat top face 14 and which are perpendicular to the flat top and bottom faces 14,13. The flat top face 14 is parallel to the flat bottom face 13.

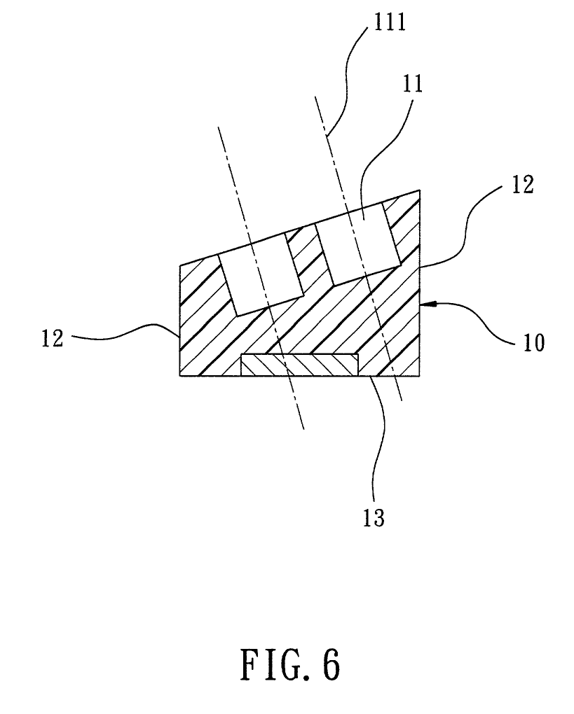

Referring to FIG. 6, a third preferred embodiment of the present invention is shown to have a structure similar to that of the first preferred embodiment. The main difference resides in that the seat body 10 has two opposite side faces 12 which extend from the flat bottom face 13 to the flat top face 14 and which are perpendicular to the flat bottom face 13. The flat top face 14 is inclined relative to the flat bottom face 13.

With this invention thus explained, it is apparent that numerous modifications and variations can be made without departing from the scope and spirit of this invention. It is therefore intended that this invention be limited only as indicated by the appended claims.

I claim:

1. A tool-holding seat comprising:
a seat body having a flat bottom face and a flat top face opposite to said flat bottom face, and formed with a plurality of parallel spaced apart bit-retention holes extending inwardly from said flat top face, each of said bit-retention holes being adapted to retain a workpiece-driving bit therein and defining an axial line along the length thereof, said axial line of each of said bit-retention holes being inclined relative to said flat bottom surface at an acute angle so as to facilitate insertion of and access to the workpiece-driving bits in said-bit retention holes; and
a magnetic piece embedded in said seat body adjacent to said flat bottom face.

2. The holding seat as defined in claim 1, wherein said seat body has two opposite inclined side faces extending from said flat bottom face to said flat top face in a direction parallel to said axial line, said flat top face being inclined relative to said flat bottom face and being perpendicular to said axial line of each of said bit-retention holes.

3. The holding seat as defined in claim 1, wherein said seat body has two opposite side faces extending from said flat bottom face to said flat top face and perpendicular to said flat top and bottom faces, said flat top face being parallel to said flat bottom face.

4. The holding seat as defined in claim 1, wherein said seat body has two opposite side faces extending from said flat bottom face to said flat top face and perpendicular to said flat bottom face, said flat top face being inclined relative to said flat bottom face.
